(19) United States
(12) Patent Application Publication
(10) Pub. No.: US 2026/0044875 A1
(43) Pub. Date: Feb. 12, 2026

(54) PROGRAM, TERMINAL, ARTICLE SUPPLY APPARATUS, AND MANAGEMENT APPARATUS

(71) Applicant: Bandai Co., Ltd., Tokyo (JP)

(72) Inventors: Hajime Kondo, Tokyo (JP); Hiroki Kobayashi, Tokyo (JP)

(21) Appl. No.: 19/167,265

(22) PCT Filed: Mar. 8, 2024
(86) PCT No.: PCT/JP2024/009143

§ 371 Date: Sep. 19, 2025

(30) Foreign Application Priority Data
Mar. 22, 2023 (JP) 2023-046091

(51) Int. Cl. G06Q 30/0207; G06Q 30/0601

(52) U.S. Cl. CPC G06Q 30/0239; G06Q 30/0222; G06Q 30/0611

(57) ABSTRACT

To provide an article supply technique that meets a demand of a consumer.

A program that enables supply of an article from an article supply apparatus capable of supplying the article. A program causes a computer to function as: an article purchase right acquisition means that acquires an article purchase right that enables purchase of the article and includes a benefit; an acquisition means that acquires article supply apparatus identification information displayed on the article supply apparatus; a settlement means that performs, by the acquired article purchase right, settlement for the purchase of the article supplied from the article supply apparatus specified with the article supply apparatus identification information; and an article supply control means that performs control to enable the supply of the article from the article supply apparatus on condition of the settlement for the purchase of the article.

### CROSS REFERENCE TO RELATED APPLICATIONS

This application is a national stage application, filed under 35 U.S. C. § 371, of International Application No. PCT/JP2024/009143, filed Mar. 8, 2024, which claims priority to Japan Application No. 2023-046091, filed Mar. 22, 2023, the contents of both of which are hereby incorporated by reference in their entirety.

### BACKGROUND

### Technical Field The present disclosure relates to a program, a terminal, an article supply apparatus, and a management apparatus.

### Background Art

Conventionally, there is an article supply apparatus from which an article of a capsule toy stored in an apparatus main body is acquired by operating a handle or the like on condition of payment of a price (for example, Japanese Unexamined Utility Model Application Publication No. 62-078998).

### BRIEF SUMMARY

In such an article supply apparatus, the number of consumers who desires supply of an article by not only a form in which the article is supplied on condition of payment of a price, but also other forms is increasing.

Therefore, the present disclosure provides an article supply apparatus, an article supply system, and a management apparatus capable of responding to a consumer who desires supply of an article in various forms.

One aspect of the present invention is a program that enables supply of an article from an article supply apparatus capable of supplying the article, the program for causing a computer to function as: an article purchase right acquisition means that acquires an article purchase right that enables purchase of the article and includes a benefit; an acquisition means that acquires article supply apparatus identification information displayed on the article supply apparatus; a settlement means that performs, by the acquired article purchase right, settlement for the purchase of the article supplied from the article supply apparatus specified with the article supply apparatus identification information; and an article supply control means that performs control to enable the supply of the article from the article supply apparatus on condition of the settlement for the purchase of the article.

One aspect of the present invention is a terminal that enables supply of an article from an article supply apparatus capable of supplying the article, the terminal including: an article purchase right acquisition means that acquires an article purchase right that enables purchase of the article and includes a benefit; an acquisition means that acquires article supply apparatus identification information displayed on the article supply apparatus; a settlement means that performs, by the acquired article purchase right, settlement for the purchase of the article supplied from the article supply apparatus specified with the article supply apparatus identification information; and an article supply control means that performs control to enable the supply of the article from the article supply apparatus on condition of the settlement for the purchase of the article.

One aspect of the present invention is an article supply apparatus capable of supplying an article, the article supply apparatus including: a display unit that displays identification information for identifying the article supply apparatus; a housing unit that houses the article; a supply unit that supplies the article housed in the housing unit; a lock unit that locks the article not to be suppliable from the supply unit; and a control unit that controls a locked state of the lock unit, in which the control unit unlocks the lock unit on condition that the identification information has been acquired and settlement for the article has been completed by an article purchase right acquired in advance.

One aspect of the present invention is a management apparatus that manages an article supply apparatus capable of supplying an article, the management apparatus including: an article purchase right provision means capable of providing an article purchase right including a benefit to a terminal; an acquisition means that acquires article supply apparatus identification information obtained from the terminal; an article purchase right presentation means capable of presenting, to the terminal, the article purchase right available for purchase of the article providable by the article supply apparatus specified with the article supply apparatus identification information; a settlement means that performs settlement for the purchase of the article by the presented article purchase right; and a provision control means that performs control to enable the provision of the article from the article supply apparatus specified with the article supply apparatus identification information on condition that completion of the settlement.

According to the present disclosure, it is possible to provide a program, a terminal, an article supply apparatus, and a management apparatus that meet a demand of a consumer and improve convenience of a user.

### BRIEF DESCRIPTION OF THE FIGURES

FIG. 1 is a schematic diagram of an article supply system according to the present embodiment.

FIG. 2 is a schematic diagram of the article supply system according to the embodiment.

FIG. 3 is a view illustrating an apparatus configuration example of a smartphone that is an example of a terminal 3.

FIG. 4 is a front view of an example of an article supply apparatus 1.

FIG. 5 is a perspective view of an example of the article supply apparatus 1.

FIG. 6 is a functional block diagram of the article supply apparatus 1.

FIG. 7 is a block diagram illustrating a functional configuration example of the terminal 3.

FIG. 8 is a block diagram illustrating a functional configuration example of a management server 4.

FIG. 9 is a table illustrating an example of article supply apparatus data D1.

FIG. 10 is a table illustrating an example of a user information database D2.

FIG. 11 is tables illustrating an example of a coupon database D3.

FIG. 12 is a table illustrating an example of a user-owned coupon database D4.

FIG. 13 is a sequence diagram of the article supply system of the present embodiment.

FIG. 14 is views for describing a series of coupon purchase screens.

FIG. 15 is views for describing a series of images displayed on the terminal 3 when a user receives provision of an article.

FIG. 16 is a flowchart of supply determination processing performed by a coupon authentication unit 623 and a lock control unit 624.

FIG. 17 is a flowchart of supply processing of the article supply apparatus 1.

### DETAILED DESCRIPTION OF VARIOUS EMBODIMENTS

### Outline of Embodiment of Present Invention

An outline of an embodiment of the present invention will be described.

To supply an article from an article supply apparatus, it is necessary to go through a settlement procedure for purchasing the article. A representative example of the settlement procedure is payment of a price (cash). Meanwhile, there is also a method of pre-paying a certain amount of money, paying for the article from the pre-paid amount, and receiving the supply of the article. Such a settlement method is to acquire an article purchase right by which an article can be purchased by pre-paying a certain amount of money.

In the present embodiment, an example of acquiring an article purchase right in advance and supplying an article from an article supply apparatus by the article purchase right will be described.

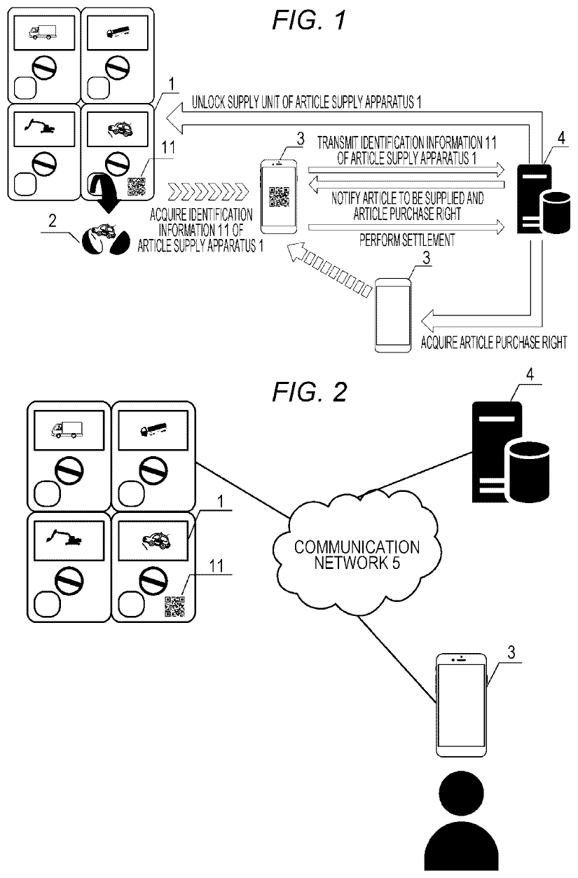

FIG. 1 is a schematic diagram of an article supply system according to the present embodiment. FIG. 1 illustrates an article supply apparatus 1, an article 2 supplied by the article supply apparatus 1, a terminal 3 of a user, and a management server 4.

The article supply apparatus 1 is an apparatus that supplies the article 2 to the user. The article supply apparatus 1 is installed indoors or outdoors, and usually, a plurality of the article supply apparatuses 1 that supply different articles is installed. The article supply apparatus 1 that supplies the article 2 displays article supply apparatus identification information 11 for identifying the article supply apparatus. The article supply apparatus identification information 11 includes unique identification information capable of identifying each article supply apparatus 1. For example, the article supply apparatus identification information 11 is a manufacturing number or the like of the article supply apparatus 1. The article supply apparatus identification information 11 is desirably an information display body readable by the terminal 3 in consideration of convenience of the user. For example, the information display body is a one-dimensional or two-dimensional barcode (QR code: registered trademark), or the like.

The terminal 3 has a reader function of the information display body and a communication function with other apparatuses. The terminal 3 is, for example, a personal computer, a tablet computer, a smartphone, a mobile phone, or the like.

The management server 4 is a server that manages the article supply apparatus 1 and an article purchase right of the user.

The user acquires the article purchase right of the article 2 from the server 4 using the terminal 3. In order for the user to acquire the article 2, it is necessary for the user to go to an installation place of the article supply apparatus 1 and receive supply of the article 2 from the article supply apparatus 1.

In view of the above, it is necessary to specify the article supply apparatus 1 capable of supplying the article 2 and to authenticate an article acquisition right of the article 2 by the user at the place where the plurality of article supply apparatuses 1 is installed, and it is necessary to enable the article supply apparatus 1 to be in a state capable of supplying the article 2 to the user under such conditions.

Therefore, the present embodiment has the following features.
(1) The article supply apparatus identification information 11 for specifying the article supply apparatus 1 capable of supplying the article desired to be purchased by the user is displayed on the article supply apparatus 1.
(2) At a place where the article supply apparatus 1 is installed, the terminal 3 of the user acquires the article supply apparatus identification information 11 of the article supply apparatus 1, and specifies the suppliable article 2 specified with the article supply apparatus identification information 11.
(3) The management server 4 notifies the terminal 3 of the suppliable article 2 and content of the available article purchase right.
(4) The user confirms the suppliable article 2 displayed on the terminal 3, and performs settlement for purchase of the article 2 by the available article purchase right.
(5) When the settlement of the article 2 is completed, the management server 4 unlocks the article supply apparatus 1 to enable the article 2 to be supplied from the article supply apparatus 1. Regarding the unlocking of the article supply in the article supply apparatus 1, an unlocking signal for unlocking a supply unit is transmitted to the article supply apparatus 1 specified with the article supply apparatus identification information 11. Then, the supply unit of the article supply apparatus 1 that has received the unlocking signal unlocks itself to enable the supply of the article 2 to the user. The management apparatus may be on a network capable of communicating with the article supply apparatus 1, or may be provided in the article supply apparatus 1 itself. In addition, in a case where the article supply apparatus 1 and the terminal 3 can communicate with each other by Wi-Fi, Bluetooth, or the like, the terminal 3 may receive determination and authentication completion information from the management apparatus, and the terminal 3 may transmit the unlocking signal to the article supply apparatus 1.

As described above, the present embodiment can supply the article to the user in a form caused by various acts of the user, and can meet the needs of various consumers such as the user to which the article is supplied and a company that intends to use the article supply apparatus.

Hereinafter, specific embodiments will be described.

### Embodiment of Present Invention

FIG. 2 is a schematic diagram of the article supply system according to the present embodiment. Note that, in FIG. 2, components similar to those in FIG. 1 are denoted by the same reference numerals.

As illustrated in FIG. 2, the article supply apparatus 1, the terminal 2 of the user, and the management server 4 are connected to a communication network 5 and can communicate with each other. The communication network 5 means a communication path capable of data communication. That is, a communication network N includes a communication network such as a telephone communication network, a cable network, or the Internet in addition to a LAN by a dedicated line (dedicated cable) or Ethernet (registered trademark) for connection, and the communication method may be wired or wireless.

The article supply apparatus 1 is an apparatus that supplies the article 2 to the user.

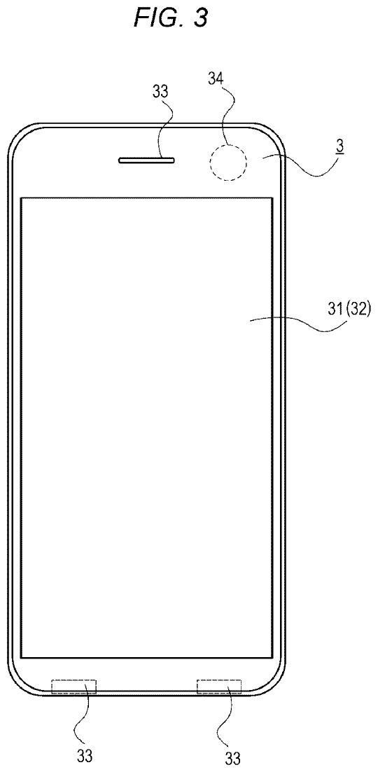

The terminal 3 is, for example, a personal computer, a tablet computer, a smartphone, a mobile phone, or the like. FIG. 3 is a view illustrating an apparatus configuration example of a smartphone that is an example of the terminal 3. As illustrated in FIG. 3, the terminal 3 includes a display 31, a touch operation panel 32 integrated with the display 31, a built-in speaker 33, and a camera 34. In addition, the terminal 3 is provided with a control board, a built-in battery, a power button, a volume adjustment button, and the like that are not illustrated. Various microprocessors such as a CPU, a GPU, and a DSP, various IC memories such as an ASIC, a VRAM, a RAM, and a ROM, a wireless communication module for wirelessly communicating with a mobile phone base station, and the like are mounted on the control board. Further, a so-called I/F circuit (interface circuit) such as a driver circuit of the touch operation panel 32 is mounted on the control board. Each element mounted on the control board is electrically connected via a bus circuit or the like, and is connected so as to be able to read and write data and transmit and receive signals.

The management server 4 is a server system including a single or a plurality of server apparatuses, storage apparatuses, and the like. The management server 4 performs processing such as sale of the article purchase right, settlement by the article purchase right, identification of the article supply apparatus 1 that supplies the article, and unlocking of the article supply apparatus 1.

Next, a configuration of each apparatus will be described.

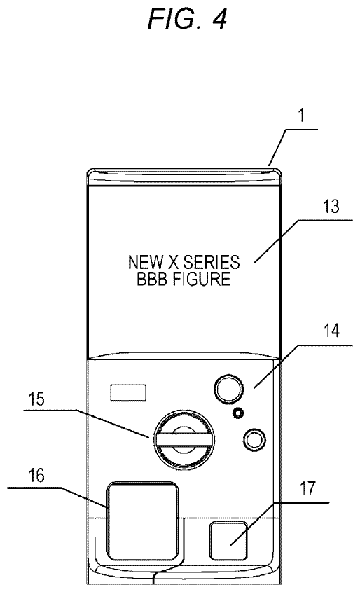

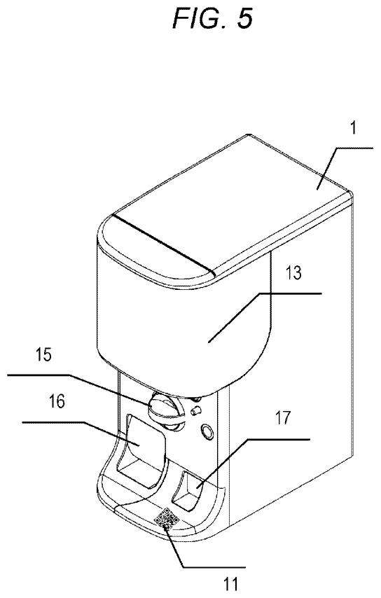

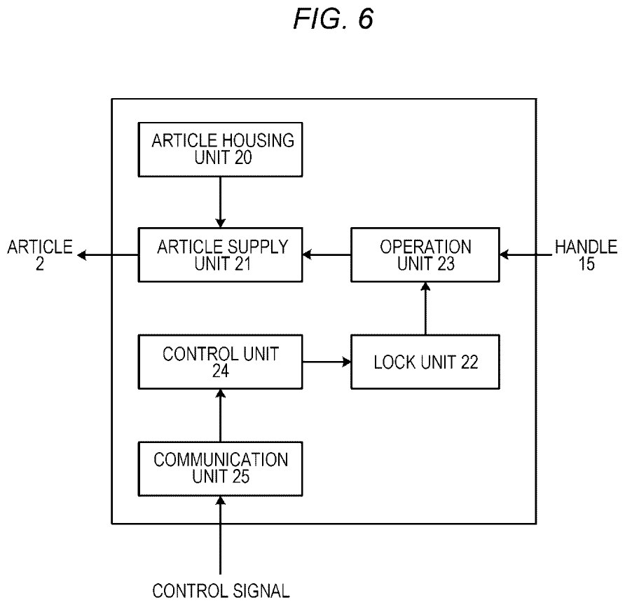

FIG. 4 is a front view of an example of the article supply apparatus 1, FIG. 5 is a perspective view of an example of the article supply apparatus 1, and FIG. 6 is a functional block diagram of the article supply apparatus 1.

The article supply apparatus 1 is an apparatus that supplies the article 2.

Examples of the article 2 include an article in which a toy or the like is housed in a dividable spherical capsule, and an article in which a toy and a capsule are integrated. The article 2 is not limited to one type of article, and a plurality of types of articles may exist. In this case, the plurality of types of articles is mixed and housed in an article housing unit 20 of the article supply apparatus 1 to be described below as articles belonging to one series (type).

On a front surface of the article supply apparatus 1, a display 13 that displays content of the article 2, an insertion slot 14 of a coin to be paid as a price for the article 2, a handle 15 as an operation unit, an extraction slot 16 to which the article 2 is supplied, and a return slot 17 of a coin are provided. The user can recognize the articles that can be supplied by the article supply apparatus 1 by visually recognizing the display 13.

The article supply apparatus 1 displays the article supply apparatus identification information 11 (information display body: QR code) for identifying the article supply apparatus 1. The article supply apparatus identification information 11 includes at least unique article supply apparatus identification information (apparatus ID) for identifying the article supply apparatus 1 and a uniform resource locator (URL) that is link information to the management server 4 for specifying the article that can be supplied by the article supply apparatus 1. Note that the article supply apparatus identification information 11 may also include other pieces of information, for example, information such as position information for identifying a place where the article supply apparatus 1 is installed, a store name, and the price of the article, and management information necessary for managing the article supply apparatus 1, in addition to the above-described information. Further, as a method of displaying the article supply apparatus identification information 11, in the present example, a method of displaying and attaching a QR code as the information display body to the article supply apparatus 1 is adopted, but the present embodiment is not limited thereto. For example, in a case where the article supply apparatus 1 includes a display unit such as a liquid crystal, the information display body of the article supply apparatus identification information 11 may be displayed on the display unit. Further, the article supply apparatus identification information 11 may be displayed at a position where a bottom surface of the return slot 17 can be visually recognized in the vicinity of the return slot 17 as illustrated in FIG. 5, for example. Since the user in the present embodiment has acquired the article purchase right, the user can acquire the article 2 without paying money such as coins. By displaying the article supply apparatus identification information 11 at such a position, there is an effect that the user easily notices a returned coin in a case where the coin erroneously inserted by the user is returned to the return slot 17.

The article supply apparatus 1 includes an article housing 20, an article supply unit 21, a lock unit 22, an operation unit 23, a control unit 24, and a communication unit 25.

The article housing unit 20 houses a large number of the articles 2. The housing of the article is configured to easily house the article by pulling the article housing unit 20 to the front and introducing the article 2 from the front of the article supply apparatus 1. An article supply unit 21 including a rotary disk having a hole of a size through which one article 2 can pass is installed in a lower portion of the article housing unit 20.

The operation unit 23 transmits an operation of the handle 15 to the rotary disk of the article supply unit 21. The operation unit 23 is locked by the lock unit 22, and when the operation unit is unlocked, the handle 15 becomes rotatable by the user's operation. As a mechanism for unlocking, for example, an unlocking mechanism using a solenoid lock is used. In this case, the handle 15 is brought into a non-rotatable state (locked state) using the solenoid lock, and the handle 15 is brought into a rotatable state by being unlocked by energizing the solenoid. Note that the unlocking mechanism is not limited to the one using the solenoid lock, and another unlocking mechanism may be used. Then, in a state where the lock unit 22 is in an unlocked state, when the rotary disk rotates in conjunction with rotation of the handle 15 by a predetermined angle, and the hole of the rotary disk and a drop slot provided in the bottom of the article housing unit 20 face each other, one article 2 is supplied through the drop slot to the extraction slot 16 through a passage communicating with the extraction slot 16.

The control unit 24 controls locking and unlocking of the lock unit 22. The unlocking of the lock unit 22 by the control unit 24 is performed by settlement with cash inserted into the insertion slot 14 or an unlocking signal controlled from an outside. In addition, the control unit 24 locks the lock unit 22 after detection of discharge of the article 2 to the extraction slot 16 or after a lapse of a predetermined time from unlocking. Furthermore, the control unit 24 may lock the lock unit 22 by a locking signal controlled from the outside.

The communication unit 25 can communicate with the management apparatus 5 via the communication network 6.

Next, a configuration of the terminal 3 will be described.

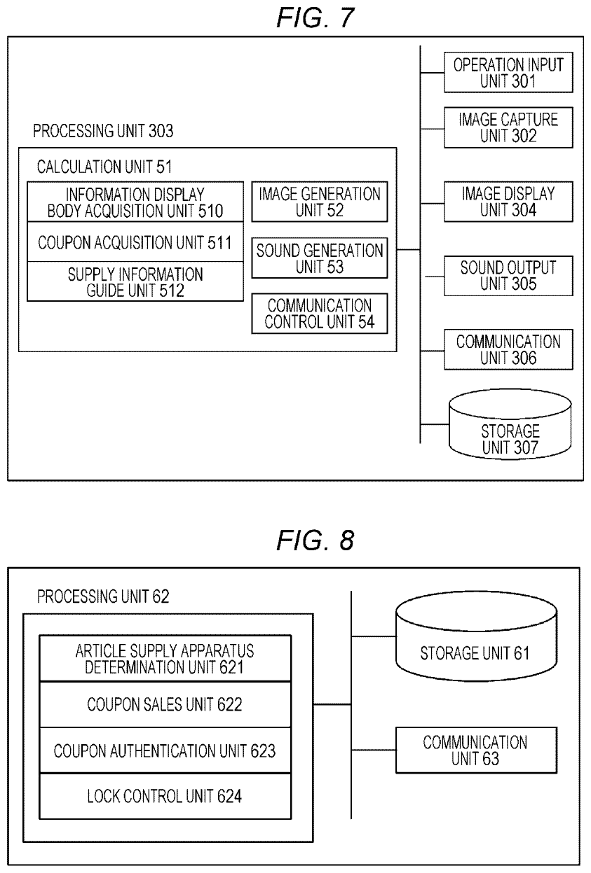

FIG. 7 is a block diagram illustrating a functional configuration example of the terminal 3. As illustrated in FIG. 7, the terminal 3 includes an operation input unit 301, an image capture unit 302, a processing unit 303, an image display unit 304, a sound output unit 305, a communication unit 306, and a storage unit 307.

The operation input unit 301 is for inputting various operations of the user, and outputs an operation input signal corresponding to an operation input to the processing unit 303. The function of the operation input unit 301 can be implemented by, for example, not only an element directly operated by the user with a finger, such as a touch operation pad, a home button, a button switch, a joystick, or a trackball, but also an element that detects motion or posture, such as an acceleration sensor, an angular velocity sensor, an inclination sensor, or a geomagnetic sensor. In FIG. 3, the touch operation panel 32 corresponds to the operation input unit.

The image capture unit 302 performs image capture processing of the information display body (QR code) of the article supply apparatus identification information 11, and outputs a captured image to the processing unit 303. The image capture unit 302 includes a lens, an imaging element, and a controller that controls the lens and the imaging element. In FIG. 3, the camera 34 corresponds to the image capture unit.

The processing unit 303 comprehensively controls the operation of the terminal 3 on the basis of programs and data stored in the storage unit 307, an operation input signal from the operation input unit 301, and the like. The function of the processing unit 303 can be implemented by, for example, a microprocessor such as a CPU or a GPU, or an electronic component such as an ASIC or an IC memory. The processing unit 303 includes a calculation unit 51, an image generation unit 52, a sound generation unit 53, and a communication control unit 54 as main functional units.

The calculation unit 51 performs an output to the image generation unit 52, the sound generation unit 53, and the communication control unit 54. The calculation unit 51 includes an information display body acquisition unit 510, a coupon acquisition unit 511, and a supply information guide unit 512.

The information display body acquisition unit 510 reads the information display body of the article supply apparatus 1 captured by the image capture unit 302, and acquires the article supply apparatus identification information 11.

The coupon acquisition unit 511 is a unit that acquires a coupon that is the article purchase right of the article 2. The coupon has the following aspects.
(1) There is a plurality of first-type coupons (first-type article purchase rights) depending on the prices. For example, there are three types of first-type coupons with the prices of 1,000 yen, 2,000 yen, and 5,000 yen. That is, there is a plurality of types of article purchase rights.
(2) Each first-type coupon (the first-type article purchase right) includes a plurality of second-type coupons (second-type article purchase rights). For example, the coupon with the price of 1,000 yen (the first-type article purchase right) includes three or more second-type coupons each having the price of 500 yen. This is because a total price of the second-type coupons becomes higher than the price of the first-type coupon in order to give the user an advantage of purchasing the first-type coupon. The price per coupon is preferably adjusted to the price of the article in consideration of convenience. However, the prices of all the second-type coupons do not need to be the same, and for example, a second-type coupon of 500 yen and a second-type coupon of 400 yen may be mixed. Further, the second-type coupon may be not only a financial coupon but also a coupon that can be exchanged for a specific article. For example, the first-type coupon of 1,000 yen may include two second-type coupons of 500 yen and one second-type coupon that can be exchanged for one specific article. Even with such a configuration, it is possible to obtain a benefit higher than the price of the first-type coupon.
(3) A ratio of a total amount of the second-type coupons to the price of the first-type coupon is set to be higher as the price of the first-type coupon is higher. For example, for the first-type coupon with the price of 1,000 yen, the total amount of the second-type coupons is set to 1,000 yen (500 yen×2), and a coupon that allows free purchase of one item is included as the benefit. For the first-type coupon with the price of 2,000 yen, the total amount of the second-type coupons is set to 2,500 yen (500 yen×5). For the first-type coupon with the price of 5,000 yen, the total amount of the second-type coupons is set to 7,500 yen (500 yen×15), and a coupon that allows free purchase of one item is included as the benefit.

The coupon acquisition unit 511 acquires information of the coupon as described above from the management server 4 and executes a purchase procedure. The purchase procedure is electronic payment such as a credit card or electronic money as will be described below.

The supply information guide unit 512 displays a guide of the article that can be supplied from the management server 4 and presentation of the available coupon on the image display unit 304 via the image generation unit 52.

Note that the functions of the information display body acquisition unit 510, the coupon acquisition unit 511, and the supply information guide unit 512 can be implemented by a web browser installed in the terminal 3, and can also be implemented by a dedicated application.

The image generation unit 52 generates one image in one frame time (for example, 1/60 seconds) on the basis of a processing result of the calculation unit 51, and outputs a generated image signal to the image display unit 304. The function of the image generation unit 52 can be implemented by, for example, a processor such as a GPU or a digital signal processor (DSP), a program such as a video signal IC or a video codec, an IC memory for a drawing frame such as a frame buffer, an IC memory used for developing texture data, or the like.

The sound generation unit 53 generates sound signals such as sound effects and various operation sounds on the basis of a processing result of the calculation unit 51, and outputs the sound signals to the sound output unit 305. The function of the sound generation unit 53 can be implemented by, for example, a processor such as a digital signal processor (DSP) or an audio synthesis IC, an audio codec capable of reproducing an audio file, or the like.

The communication control unit 54 performs communication connection and data processing for data communication with the management apparatus 5 and the like.

The image display unit 304 displays a screen on the basis of the image signal input from the image generation unit 52. The function of the image display unit 304 can be implemented by, for example, a display apparatus such as a flat panel display, a cathode ray tube (CRT), a projector, or a head mounted display. In FIG. 2, the image display unit 304 corresponds to the display 31.

The sound output unit 305 is for outputting a sound effect or the like on the basis of a sound signal input from the sound generation unit 53. In FIG. 2, the sound output unit 203 corresponds to the speaker 33.

The communication unit 306 is connected to a communication line N and implements communication. The function of the communication unit 306 can be implemented by, for example, a wireless communication apparatus, a modem, a terminal adapter (TA), a jack of a wired communication cable, a control circuit, or the like.

In the storage unit 307, a program for operating the terminal 3 and implementing the various functions of the terminal 3, data used during execution of the program, and the like are stored in advance, or temporarily stored each time processing is performed. The storage unit 307 can be implemented by, for example, an IC memory such as a RAM, a ROM, or a flash memory, a magnetic disk such as a hard disk, an optical disk such as a CD-ROM or a DVD, or the like. Specifically, the storage unit 307 stores a system program and a control program. The system program is a program for implementing a basic function of the terminal 3 as a computer. The control program is a program for causing the calculation unit 51 (information display body acquisition unit 510, coupon acquisition unit 511, and supply information guide unit 512) of the processing unit 31 to function.

Next, the management server 4 will be described.

FIG. 8 is a block diagram illustrating a functional configuration example of the management server 4. The management server 4 includes a storage unit 61, a processing unit 62, and a communication unit 63.

The storage unit 61 can be implemented by, for example, an IC memory such as a RAM, a ROM, or a flash memory, a magnetic disk such as a hard disk, an optical disk such as a CD-ROM or a DVD, or the like, and stores a system program and function program. The system program is a program for implementing a basic function as a computer. The function program is a program for causing the processing unit 62 to function as an article supply apparatus determination unit 621, an acquisition right authentication unit 622, a coupon sales unit 622, a coupon authentication unit 623, and a lock control unit 624 to be described below. In addition, each database to be described below is stored. Each stored database will be described.

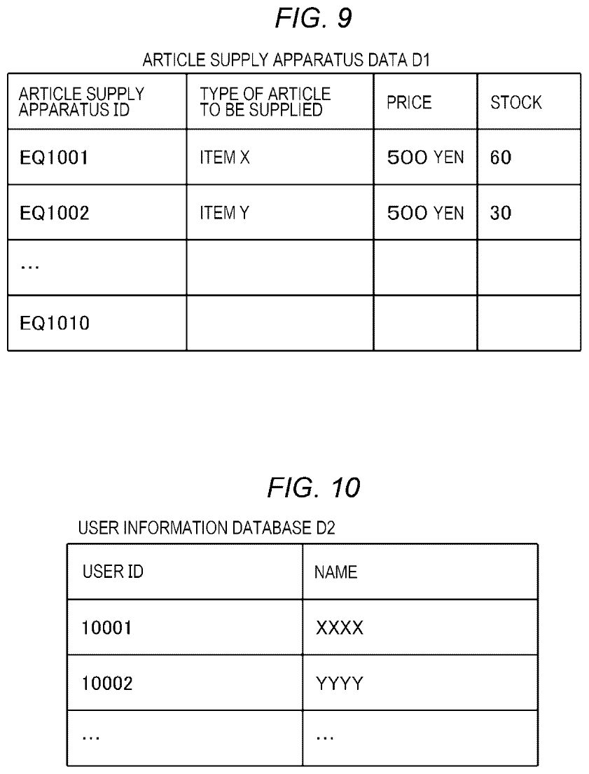

Article supply apparatus data D1 stores the article supply apparatus identification information (ID) of the article supply apparatus 1 capable of supplying the article 2, a type (item name) of the article 2 provided by the article supply apparatus 1, and a quantity in stock in association with one another. FIG. 9 is a table illustrating an example of the article supply apparatus data D1. As illustrated in FIG. 9, the article supply apparatus data D1 stores the article supply apparatus ID of the article supply apparatus 1 capable of supplying the article 2, the type (item name) of the article 2, and the quantity in stock in association with one another.

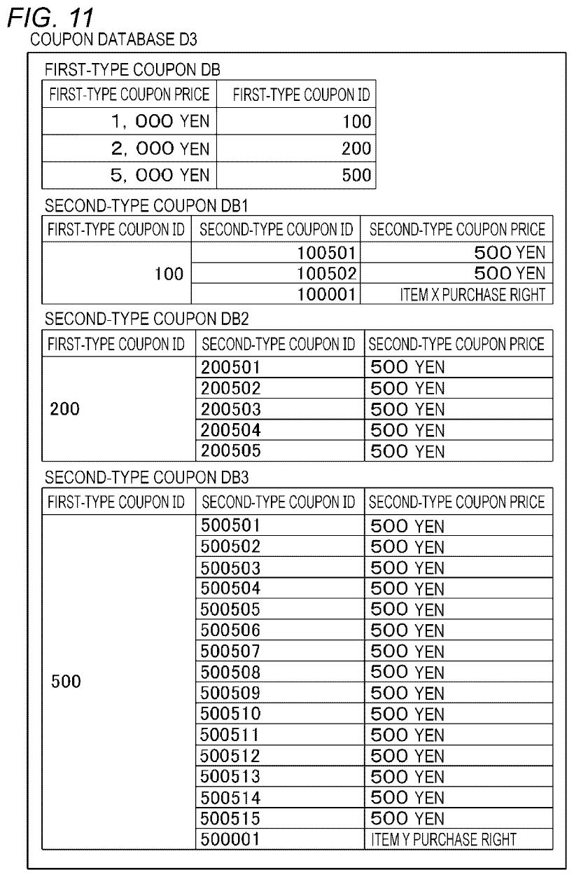

User information database D2 stores user identification information (user ID) and a name in association with each other. FIG. 10 is a table illustrating an example of the user information database D2. As illustrated in FIG. 10, the user identification information (user ID) and the name are stored in association with each other.

Coupon database D3 is a database related to the coupon that can be sold to the user. FIG. 11 is tables illustrating an example of the coupon database D3. The coupon database D3 includes a first-type coupon database and a plurality of second-type coupon databases.

The first-type coupon database stores a coupon price of the first-type coupon and first-type coupon identification information in association with each other. The second-type coupon database is prepared for each type of the first-type coupon. In the present example, since the first-type coupons are of 1,000 yen, 2,000 yen, and 5,000 yen, three second-type coupon databases 1 to 3 are stored. The second-type coupon databases 1 to 3 include the first-type coupon identification information, the coupon identification information of the second-type coupons included in the first-type coupon, and content thereof (price, benefit, and the like). For example, the second-type coupon database 1 stores two second-type coupons of 500 yen and the benefit that allows free purchase of an item X in association with the first-type coupon identification information and the second-type coupon identification information.

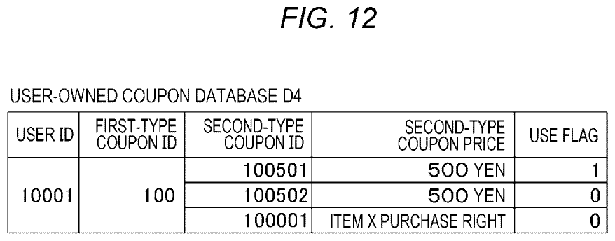

A user-owned coupon database D4 is a database that stores the coupons owned by the user. FIG. 12 is a table illustrating an example of the user-owned coupon database D4. In the example of FIG. 12, the user ID, the owned first-type coupon identification information, the second-type coupon identification information included in the first-type coupon, and a flag of whether each of the second-type coupons has been used are stored in association with one another.

The processing unit 62 comprehensively controls the operation of the management apparatus 5 on the basis of the programs and data stored in the storage unit 61. The function of the processing unit 62 can be implemented by, for example, a microprocessor such as a CPU or a GPU, or an electronic component such as an ASIC or an IC memory. The processing unit 62 includes an acquisition right authentication unit 622, a coupon sales unit 622, a coupon authentication unit 623, and a lock control unit 624 as main functional units.

The article supply apparatus determination unit 621 receives an article provision request from the terminal 3, acquires the article supply apparatus ID included in the request, and determines whether the acquired article supply apparatus ID is included in the article supply apparatus data D1. In a case where the article supply apparatus ID is included in the article supply apparatus data D1, the article supply apparatus determination unit 621 checks the article to be supplied of the article supply apparatus 1 of the apparatus ID and its quantity in stock, and transmits an article purchase screen to the terminal 3 of the user in a case where there is a quantity in stock. On the other hand, in a case where the article supply apparatus ID is not included in the article supply apparatus data D1, or in a case where there is no stock even if the article supply apparatus ID is included in the article supply apparatus data DI, the article supply apparatus determination unit 621 transmits an error screen for guiding that the supply of the article 2 is not possible to the terminal 3.

The coupon sales unit 622 receives a coupon purchase request from the terminal 3, and transmits the type of a currently providable coupon to the terminal 3. In addition, in a case where the user purchases the coupon, the first-type coupon ID of the purchased coupon and second-type coupon IDs are added to the user-owned coupon database D4 corresponding to the user ID of the user. At this time, a user-owned coupon database D4 similar to the user-owned coupon database D4 may also be recorded in the terminal 3, and data may be synchronized between the terminal 3 and the management server 4.

The coupon authentication unit 623 receives the article provision request from the terminal 3, reads the available coupon (a use flag is “0”) from the user-owned coupon database D4 of the user ID of the user, and includes the coupon in the article purchase screen. Further, in a case where the coupon has been authenticated and used by the provision of the article, the use flag corresponding to the used second-type coupon ID in the user-owned coupon database D4 is changed from “0” to “1”. At this time, the user-owned coupon database D4 recorded in the terminal 3 may be updated, and data may be synchronized between the terminal 3 and the management server 4.

In a case where the coupon has been authenticated by the coupon authentication unit 623, the lock control unit 624 transmits the unlocking signal to the acquired article supply apparatus ID.

An operation of the system of the present embodiment will be described.

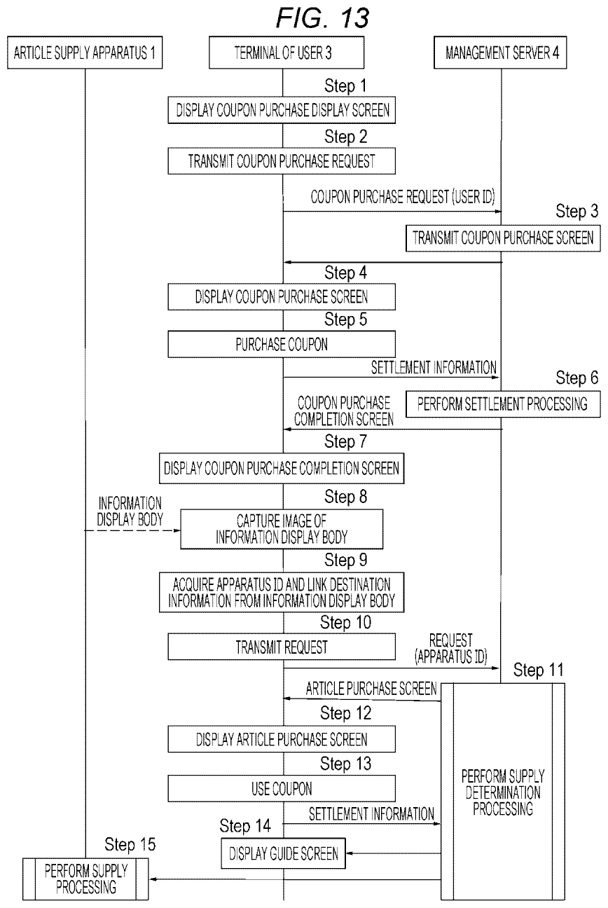

FIG. 13 is a sequence diagram of the article supply system of the present embodiment. Note that the operation will be described with reference to the content of the databases in FIGS. 9 to 11.

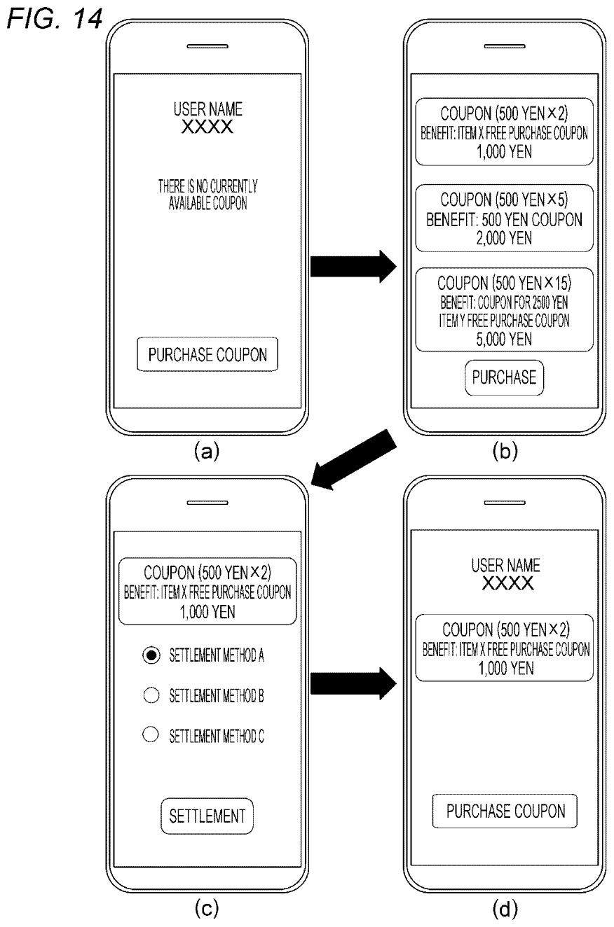

The user purchases the available coupon using the terminal 3. The purchase is performed by activating the coupon acquisition unit 511. FIG. 14 is views for describing a series of coupon purchase screens. The coupon acquisition unit 511 displays the coupon purchase screen (Step 1 in FIG. 14(a)). The example of FIG. 14(a) illustrates a state in which the user “XXXX” has no available coupon. Here, the user selects a coupon purchase button to purchase a coupon. When the coupon purchase button is selected, the coupon acquisition unit 511 transmits a coupon purchase request including the user ID of the user “XXXX” (Step 2).

The coupon sales unit 622 of the management server 4, which has received the coupon purchase request, reads the type of the currently providable coupon from the coupon database D3, and transmits the coupon purchase screen to the terminal 3 (Step 3). Here, the providable first-type coupons are the coupons of 1,000 yen, 2,000 yen, and 5,000 yen, the content of the second-type coupons included in each of the first-type coupons is also read, and the coupon purchase screen is transmitted to the terminal 3.

The coupon acquisition unit 511 of the terminal 3, which has received the coupon purchase screen, displays the coupon purchase screen (Step 4). An example of the coupon purchase screen is illustrated in FIG. 14(b). In the example of FIG. 14(b), the three types of first-type coupons of 1,000 yen, 2,000 yen, and 5,000 yen, and the content of the second-type coupons are displayed. The user selects the coupon that the user desires to purchase, and selects a purchase button. Then, processing transitions to selection of a settlement method, and the settlement method is selected and a settlement button is selected (FIG. 14(c)). The coupon acquisition unit 511 of the terminal 3 transmits settlement information including the user ID, the first-type coupon ID of the selected coupon, and the settlement method to the management server 4 (Step 5).

The coupon sales unit 622 of the management server 4, which has received the settlement information, performs settlement processing for the price corresponding to the first-type coupon ID by the specified settlement method (Step 6). Then, when the settlement is completed, the purchased first-type coupon ID and the second-type coupon IDs of the second-type coupons included in the first-type coupon are added to the user-owned coupon database D4 corresponding to the user ID. In the present example, since the user “XXXX” has purchased the coupon of 1,000 yen, the first-type coupon ID “100” and the second-type coupon IDs “100501”, “100502”, and “100001” are added to the user-owned coupon database D4 of the user ID “10001” of the user “XXXX” as illustrated in FIG. 12. When the settlement processing is completed, the coupon sales unit 622 transmits a coupon purchase completion screen.

The coupon acquisition unit 511 of the terminal 3, which has received the coupon purchase completion screen, displays the coupon purchase completion screen (Step 7). An example of the coupon purchase completion screen is illustrated in FIG. 14(d). In the example of FIG. 14(d), it is displayed that the user owns the coupon of 1,000 yen.

As described above, the user acquires the coupon.

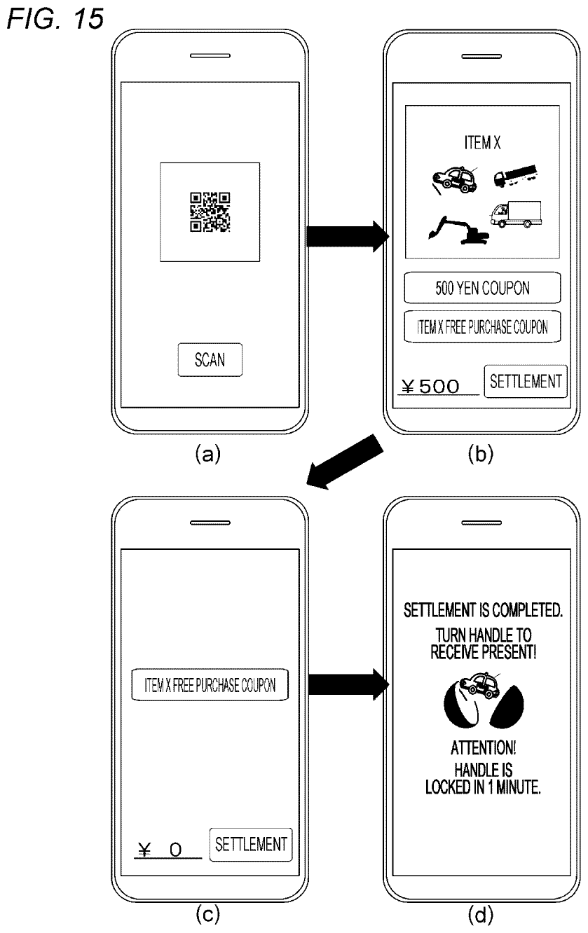

Next, an operation in which the user receives provision of the article will be described. FIG. 15 is views for describing a series of images displayed on the terminal 3 when the user receives provision of the article.

The user goes to the place where the article supply apparatus 1 capable of supplying the article 2 is installed, and acquires the information display body of the article supply apparatus identification information 11 displayed on the article supply apparatus 1. The information display body is acquired by using an image capture function of the image capture unit 302 of the terminal 3 according to the user's operation (Step 8). FIG. 15(a) is a view illustrating an image capture example of the information display body of the article supply apparatus identification information 11 of the article supply apparatus 1 by the image capture unit 302 of the terminal 3. The user stands in front of the article supply apparatus 1, operates the terminal 3 so that the information display body of the article supply apparatus identification information 11 is displayed on the display 31 of the terminal 3, and captures an image of the information display body.

The information display body acquisition unit 510 of the terminal 3 acquires the article supply apparatus identification information 11 from the information display body of the captured article supply apparatus identification information 11. In the present example, the acquired article supply apparatus identification information 11 includes the apparatus ID of the article supply apparatus 1 and is link destination information (for example, a URL) to the article purchase screen (Step 9). In the present example, it is assumed that the acquired apparatus ID is “EQ1001” and the management server 4 is set as the link destination. Then, it is assumed that the request includes the user ID “10001”.

The supply information guide unit 512 transmits a request (including the user ID) of the article purchase screen to the management server 4 on the basis of the apparatus ID and the link destination of the article supply apparatus 1 acquired by the information display body acquisition unit 510 of the terminal 3 (Step 10).

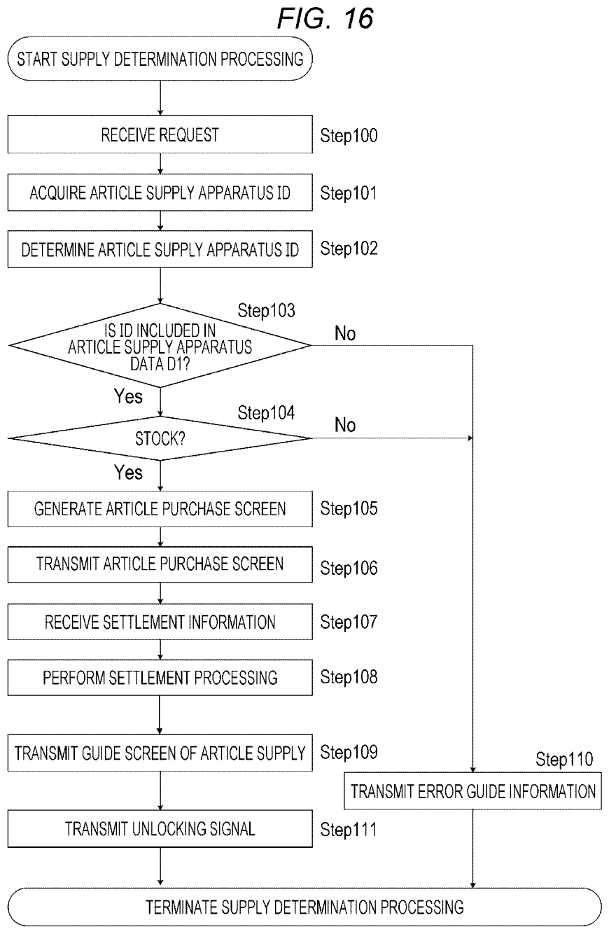

The management server 4 receives the request from the terminal 3 and performs supply determination processing (Step 11). FIG. 16 is a flowchart of the supply determination processing performed by the coupon authentication unit 623 and the lock control unit 624.

When receiving the request from the terminal 3 (Step 100), the coupon authentication unit 623 acquires the apparatus ID included in the request (Step 101). In the present example, the article supply apparatus ID is “EQ1001”.

The coupon authentication unit 623 determines the article supply apparatus ID using the article supply apparatus data D1 (Step 102). The determination of the article supply apparatus ID is determination of whether the acquired article supply apparatus ID is included in the article supply apparatus data D1. In a case where the acquired article supply apparatus ID is included in the article supply apparatus data D1 (Step 103), it is determined that the article supply apparatus 1 with the article supply apparatus ID acquired by the user is the article supply apparatus 1 capable of supplying the article 2, and the article supply apparatus 1 that transmits the unlocking signal is specified. On the other hand, in a case where the acquired apparatus ID is not included in the article supply apparatus data D1 (Step 103), it is determined that the article supply apparatus 1 is not the article supply apparatus 1 capable of supplying the article 2, and error guide information is transmitted to the terminal 3 (Step 110). In the present example, since the acquired article supply apparatus ID is “EQ1001” and is included in the article supply apparatus data D1, it is determined that the article supply apparatus 1 from which the user intends to receive the supply of the article is the article supply apparatus 1 with the article supply apparatus ID “EQ1001”.

Subsequently, the coupon authentication unit 623 confirms the stock of the article 2 of the article supply apparatus 1 with the acquired article supply apparatus ID (Step 104). In a case where the quantity in stock of the acquired article supply apparatus ID in the article supply apparatus data D1 is not “0”, the coupon authentication unit 623 determines that the article supply apparatus 1 with the acquired article supply apparatus ID can supply the article 2 and specifies the article supply apparatus 1 to which the unlocking signal is transmitted. On the other hand, in a case where the quantity in stock of the acquired article supply apparatus ID in the article supply apparatus data D1 is “0”, the coupon authentication unit 623 transmits the error guide information to the terminal 3 (Step 110).

In a case where there is a stock of the article 2 of the article supply apparatus 1 with the acquired article supply apparatus ID, the coupon authentication unit 623 generates the article purchase screen (Step 105). The coupon authentication unit 623 reads the type and price supplied by the acquired article supply apparatus ID, reads the coupon applicable to purchase the article from the user-owned coupon database D4, and generates the article purchase screen. Then, the coupon authentication unit 623 transmits the article purchase screen to the terminal 3 (Step 106). In the present example, the article that can be supplied by the article supply apparatus 1 with the article supply apparatus ID “EQ1001” is an “item X”, and the price is “500 yen”. Meanwhile, in the user-owned coupon database D4 with the user ID “10001”, there are available second-type coupon IDs “100501” and “100001”, the second-type coupon ID “100501” is of 500 yen, and the second-type coupon ID “100001” is of the item X purchase right, and thus both can be used. The coupon authentication unit 623 generates and transmits the article purchase screen using the article “item X” that can be supplied by the article supply apparatus 1 with the article supply apparatus ID “EQ1001”, the price “500 yen” thereof, and the second-type coupon IDs “100501” and “100001”.

The supply information guide unit 512 of the terminal 3, which has received the article purchase screen, displays the article purchase screen (Step 12). FIG. 15(b) illustrates an example of the article purchase screen displayed on the terminal 3. In the example of FIG. 15(b), the suppliable article “item X”, the price thereof, and the coupon buttons (500 yen coupon and item X free purchase coupon) applicable to the article purchase are displayed.

When the user selects one of coupon application buttons in order to apply the coupon, the supply information guide unit 512 causes the screen to transition to a settlement screen. The settlement screen of FIG. 15(c) is a settlement screen in a case where the user selects the item X free purchase coupon. When the user selects a settlement button on the settlement screen, the supply information guide unit 512 transmits the settlement information (Step 13). The settlement information includes the user ID and the coupon ID of the used coupon. In the present example, the user ID “10001” and the second-type coupon ID “100001” are included.

When receiving the settlement information (Step 107), the coupon authentication unit 623 performs the settlement processing (Step 108). The settlement processing is performed by updating the user-owned coupon database D4 using the user ID and the second-type coupon ID included in the received settlement information. In the present example, since the user ID “10001” and the second-type coupon ID “100001” are included in the settlement information, the settlement processing is performed by updating the use flag of the second-type coupon ID “100001” in the user-owned coupon database D4 of the user ID “10001” to “1”. As a result, the coupon with the second-type coupon ID “100001” becomes used.

When the settlement processing is completed, the coupon authentication unit 623 transmits a guide screen for article supply (Step 109). Further, the coupon authentication unit 623 notifies the lock control unit 624 of the completion of the settlement and the article supply apparatus ID.

The lock control unit 624 transmits the unlocking signal to the article supply apparatus 1 specified with the article supply apparatus ID (Step 111). In the present example, the lock control unit 624 transmits the unlocking signal to the article supply apparatus 1 with the article supply apparatus ID “EQ1001”.

The description of the supply determination processing of the management server 4 ends.

The supply information guide unit 512 of the terminal 3 receives guide information from the management server 4 and displays the guide information (Step 14). FIG. 15(d) is an example of the guide information displayed on the terminal 3. In the guide information of FIG. 15(d), the settlement having been completed, operating the handle 15 of the article supply apparatus 1 to receive the article, and locking the handle 15 in 1 minute are given. The user operates the article supply apparatus 1 according to the guide information.

The article supply apparatus 1 receives the unlocking signal and performs supply processing (Step 15). Then, the article supply apparatus 1 transmits a supply report to the management server 4. Note that the management server 4 receives the supply report and updates the quantity in stock.

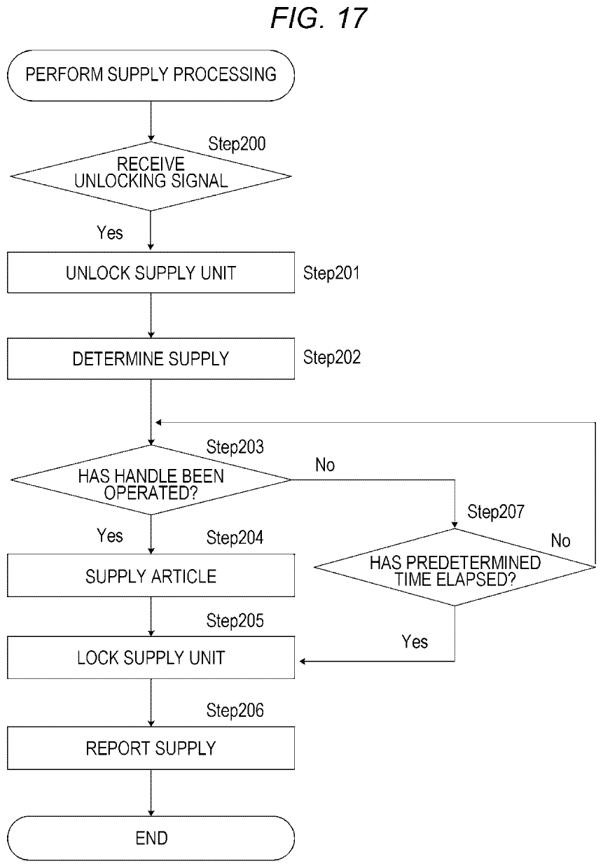

Next, the supply processing (Step 15) of the article supply apparatus 1 will be described with reference to the flowchart of FIG. 17.

When receiving the unlocking signal (Step 200), the control unit 24 of the article supply apparatus 1 unlocks the lock unit 22 (Step 201).

The control unit 24 of the article supply apparatus 1 determines supply of the article 2 (Step 202). First, the control unit 24 determines whether the handle 15 of the operation unit 23 has been operated (for example, one rotation) (Step 203). When the handle 15 is operated (for example, one rotation), one article 2 is supplied from the article supply unit 21 to the extraction slot 16 (Step 204). Then, the control unit 24 locks the lock unit 22 (Step 205).

On the other hand, in a case where the handle 15 has not been operated (Step 203), the control unit 24 determines whether a predetermined time (for example, 1 minute) has elapsed since the unlocking (Step 207). In a case where the handle 15 has not been operated (Step 203) and a predetermined time (for example, 1 minute) has elapsed since the unlocking (Step 207), the control unit 24 locks the lock unit 22 (Step 205).

Finally, the control unit 24 makes a supply report indicating that the article 2 has been normally supplied in a case where the article 2 has been normally supplied, and makes a supply report indicating that the article 2 has not been supplied in a case where the article 2 has not been supplied (Step 206).

Regarding the control from the unlocking of the lock unit 22 to the locking, the above-described example has been given in which the control unit 24 determines whether a predetermined time has elapsed since the unlocking and sets the lock unit 22 to the locked state in a case where the predetermined time has elapsed. This is an example, and for example, in a case where the lock control unit 623 of the management server 4 measures a time from the transmission of the unlocking signal and does not receive the supply report indicating that the article 2 has been normally supplied until a predetermined time elapses, the control unit 24 may transmit the locking signal to the control unit 24 of the article supply apparatus 1. In this case, when receiving the locking signal, the control unit 24 sets the lock unit 22 to the locked state.

The description of the supply processing (Step 15) of the article supply apparatus 1 ends.

The present embodiment improves the convenience of the user by giving many benefits, for example, a benefit of lowering a purchase price per article and a benefit of being able to acquire a special article for free to the user who purchases the article. In particular, there is a great advantage for the user who intends to purchase many articles.

In addition, since all pieces of the settlement processing are performed electronically, there is no burden of physical money settlement, collection thereof, and the like, and it is effective not only for the user but also for a company or the like that provides the article supply apparatus.

### Modification 1 of Embodiment of Present Invention

In the above-described embodiment, the case has been described in which the first-type coupons include the flat-rate coupons and benefits, and the user can gain a profit from the first-type coupons in totality. However, the same benefit may be included in a plurality of types of the first-type coupons. For example, it may be configured such that a coupon by which a same item can be acquired for free is included in the first-type coupons of 1,000 yen, 2,000 yen, and 5,000 yen.

The advantage of such a configuration is to enable articles of the same item to get widely known to the users for a certain campaign.

### Modification 2 of Embodiment of Present Invention

In the above-described embodiment, an example has been described in which, when settlement for purchase of a certain article is made, the coupon applicable to the settlement can be selected by the user. However, a certain second-type benefit coupon may be used after all the other coupons are used. For example, it may be configured such that the coupon by which the article (item) can be acquired for free can be used after all the flat-rate coupons are used.

This configuration enables the user to first use the coupon that can be used for any item.

### Modification 3 of Embodiment of Present Invention

In the above-described embodiment, the case in which the flat rate (500 yen) is applied to the second-type coupon has been described. In such a case, if only an item of 500 yen can be purchased, it may be inconvenient for the user in many cases. Therefore, it may be configured to enable settlement if the price of the article that the user desires to be supplied is equal to or lower than the price of the second-type coupon.

### Modification 4 of Embodiment of Present Invention

Expiration dates by which both the first-type coupon and the second-type coupon can be used for settlement may be provided. This configuration enables the user to use the coupons before the expiration dates, and thus both the user and the article provider have an advantage.

Some or all of the above embodiments are also described as, but not limited to, the following supplementary notes.

### Supplementary Note 1

A program that enables supply of an article from an article supply apparatus capable of supplying the article, the program for causing a computer to function as:
an article purchase right acquisition means that acquires an article purchase right that enables purchase of the article and includes a benefit;
an acquisition means that acquires article supply apparatus identification information displayed on the article supply apparatus;
a settlement means that performs, by the acquired article purchase right, settlement for the purchase of the article supplied from the article supply apparatus specified with the article supply apparatus identification information; and
an article supply control means that performs control to enable the supply of the article from the article supply apparatus on condition of the settlement for the purchase of the article.

### Supplementary Note 2

The program according to supplementary note 1, in which the benefit includes at least one of a benefit of lowering a purchase price of an article or a benefit of enabling acquisition of an article for free.

### Supplementary Note 3

The program according to supplementary note 1 or 2, in which the settlement for the purchase of the article by the article purchase right is electronic payment and does not include cash payment.

### Supplementary Note 4

The program according to any one of supplementary notes 1 to 3, in which the article purchase right acquisition means is capable of acquiring a plurality of first-type article purchase rights.

### Supplementary note 5

The program according to any one of supplementary notes 1 to 4, in which
the first-type article purchase right includes a plurality of second-type article purchase rights, and
a type of the first-type article purchase right varies depending on a number of the included second-type article purchase rights.

### Supplementary Note 6

The program according to any one of supplementary notes 1 to 5, in which the first-type article purchase right is acquired at a higher price as the number of included second-type article purchase rights is larger.

### Supplementary Note 7

The program according to any one of supplementary notes 1 to 6, in which the settlement means disables use of the used second-type article purchase right by settlement for the purchase of the article by the second-type article purchase right.

### Supplementary Note 8

The program according to any one of supplementary notes 1 to 7, in which the plurality of types of the first-type article purchase rights includes the same benefit.

### Supplementary Note 9

The program according to any one of supplementary notes 1 to 8, in which the settlement means controls the benefit so as to be available on condition that all settlements of the second-type article purchase rights are completed.

### Supplementary Note 10

The program according to any one of supplementary notes 1 to 9, in which
a first price is set for the second-type article purchase right, and
the benefit of enabling acquisition of an article for free is a benefit of enabling acquisition of one article of the first price or less.

### Supplementary Note 11

The program according to any one of supplementary notes 1 to 10, in which the settlement means controls the first-type article purchase right to be settleable only within a certain period from an acquisition date.

### Supplementary Note 12

A terminal that enables supply of an article from an article supply apparatus capable of supplying the article, the terminal including:
an article purchase right acquisition means that acquires an article purchase right that enables purchase of the article and includes a benefit;
an acquisition means that acquires article supply apparatus identification information displayed on the article supply apparatus;
a settlement means that performs, by the acquired article purchase right, settlement for the purchase of the article supplied from the article supply apparatus specified with the article supply apparatus identification information; and
an article supply control means that performs control to enable the supply of the article from the article supply apparatus on condition of the settlement for the purchase of the article.

### Supplementary Note 13

An article supply apparatus capable of supplying an article, the article supply apparatus including:
a display unit that displays identification information for identifying the article supply apparatus;
a housing unit that houses the article;
a supply unit that supplies the article housed in the housing unit;
a lock unit that locks the article not to be suppliable from the supply unit; and
a control unit that controls a locked state of the lock unit, in which
the control unit unlocks the lock unit on condition that the identification information has been acquired and settlement for the article has been completed by an article purchase right acquired in advance.

### Supplementary Note 14

A management apparatus that manages an article supply apparatus capable of supplying an article, the management apparatus including:
an article purchase right provision means capable of providing an article purchase right including a benefit to a terminal;
an acquisition means that acquires article supply apparatus identification information obtained from the terminal;
an article purchase right presentation means capable of presenting, to the terminal, the article purchase right available for purchase of the article providable by the article supply apparatus specified with the article supply apparatus identification information;
a settlement means that performs settlement for the purchase of the article by the presented article purchase right; and
a provision control means that performs control to enable the provision of the article from the article supply apparatus specified with the article supply apparatus identification information on condition that completion of the settlement.

### Supplementary Note 15

The management apparatus according to supplementary note 14, in which
the article purchase right includes a plurality of the article purchase rights and the benefit of enabling acquisition of an article for free, and
the settlement means performs settlement for the acquisition of the article by the article purchase right and the benefit by electronic payment.

Although the present invention has been described above with reference to the preferred embodiments, the present invention is not necessarily limited to the above-described embodiments, and various modifications and implementations can be made within the scope of the technical idea.

1. A non-transitory computer readable medium having recorded therein a program that enables supply of an article from an article supply apparatus capable of supplying the article, the program for causing a computer to function as:
an article purchase right acquisition unit that acquires an article purchase right that enables purchase of the article and includes a benefit;
an acquisition unit that acquires article supply apparatus identification information displayed on the article supply apparatus;
a settlement unit that performs, by the acquired article purchase right, settlement for the purchase of the article supplied from the article supply apparatus specified with the article supply apparatus identification information; and
an article supply control unit that performs control to enable the supply of the article from the article supply apparatus based on the settlement for the purchase of the article.

2. The non-transitory computer readable medium having recorded therein the program according to claim 1, wherein
the benefit includes at least one of a benefit of lowering a purchase price of an article or a benefit of enabling acquisition of an article for free.

3. The non-transitory computer readable medium having recorded therein the program according to claim 1, wherein
the settlement for the purchase of the article by the article purchase right is electronic payment and does not include cash payment.

4. The non-transitory computer readable medium having recorded therein the program according to claim 3, wherein
the article purchase right acquisition unit is capable of acquiring a plurality of first-type article purchase rights.

5. The non-transitory computer readable medium having recorded therein the program according to claim 4, wherein
the first-type article purchase right includes a plurality of second-type article purchase rights, and
a type of the first-type article purchase right varies depending on a number of the included second-type article purchase rights.

6. The non-transitory computer readable medium having recorded therein the program according to claim 5, wherein
the first-type article purchase right is acquired at a higher price as the number of included second-type article purchase rights is larger.

7. The non-transitory computer readable medium having recorded therein the program according to claim 5, wherein
the settlement unit disables use of the used second-type article purchase right by settlement for the purchase of the article by the second-type article purchase right.

8. The non-transitory computer readable medium having recorded therein the program according to claim 5, wherein
the plurality of types of the first-type article purchase rights includes the same benefit.

9. The non-transitory computer readable medium having recorded therein the program according to claim 5, wherein
the settlement unit controls the benefit so as to be available on condition that all settlements of the second-type article purchase rights are completed.

10. The non-transitory computer readable medium having recorded therein the program according to claim 2, wherein
a first price is set for the second-type article purchase right, and
the benefit of enabling acquisition of an article for free is a benefit of enabling acquisition of one article of the first price or less.

11. The non-transitory computer readable medium having recorded therein the program according to claim 4, wherein
the settlement unit controls the first-type article purchase right to be settleable only within a certain period from an acquisition date.

12. A terminal that enables supply of an article from an article supply apparatus capable of supplying the article, the terminal comprising:
an article purchase right acquisition unit that acquires an article purchase right that enables purchase of the article and includes a benefit;
an acquisition unit that acquires article supply apparatus identification information displayed on the article supply apparatus;
a settlement unit that performs, by the acquired article purchase right, settlement for the purchase of the article supplied from the article supply apparatus specified with the article supply apparatus identification information; and
an article supply control unit that performs control to enable the supply of the article from the article supply apparatus on condition of the settlement for the purchase of the article.

13. An article supply apparatus capable of supplying an article, the article supply apparatus comprising:
a display unit that displays identification information for identifying the article supply apparatus;
a housing unit that houses the article;
a supply unit that supplies the article housed in the housing unit;
a lock unit that locks the article not to be suppliable from the supply unit; and
a control unit that controls a locked state of the lock unit, wherein
the control unit unlocks the lock unit on condition that the identification information has been acquired and settlement for the article has been completed by an article purchase right acquired in advance.

14. A management apparatus that manages an article supply apparatus capable of supplying an article, the management apparatus comprising:
an article purchase right provision unit capable of providing an article purchase right including a benefit to a terminal;
an acquisition unit that acquires article supply apparatus identification information obtained from the terminal;
an article purchase right presentation unit capable of presenting, to the terminal, the article purchase right available for purchase of the article providable by the article supply apparatus specified with the article supply apparatus identification information;
a settlement unit that performs settlement for the purchase of the article by the presented article purchase right; and
a provision control unit that performs control to enable the provision of the article from the article supply apparatus specified with the article supply apparatus identification information on condition that completion of the settlement.

15. The management apparatus according to claim 14, wherein
the article purchase right includes a plurality of the article purchase rights and the benefit of enabling acquisition of an article for free, and
the settlement unit performs settlement for the acquisition of the article by the article purchase right and the benefit by electronic payment.
